(19) United States
(12) Patent Application Publication
(10) Pub. No.: US 2026/0222162 A1
(43) Pub. Date: Jul. 30, 2026

(54) DEVICE AND METHOD OF COMMUNICATION

(71) Applicant: NEC Corporation, Tokyo (JP)

(72) Inventors: Peng GUAN, Beijing (CN); Yukai GAO, Beijing (CN); Gang WANG, Beijing (CN)

(73) Assignee: NEC Corporation, Tokyo (JP)

(21) Appl. No.: 19/140,695

(22) PCT Filed: Dec. 20, 2022
(86) PCT No.: PCT/CN2022/140512

§ 371 Date: Jun. 18, 2025

(51) Int. Cl. H04L 5/00; H04W 72/231

(52) U.S. Cl. CPC H04L 5/0094; H04W 72/231; H04L 5/0035

(57) ABSTRACT

Embodiments of the present disclosure relate to devices and methods of communication. In one aspect, a terminal device receives DCI scheduling a PDSCH transmission in a CJT scheme, the DCI indicating a set of TCI states; receive information of QCL parameter compensation for the PDSCH transmission; and receive the PDSCH transmission based on the set of TCI states and the information of QCL parameter compensation. In this way, PDSCH CJT may be supported within a unified TCI framework.

### TECHNICAL FIELD

Example embodiments of the present disclosure generally relate to the field of telecommunication and in particular, to devices and methods of communication in a unified transmission configuration indicator (TCI) framework.

### BACKGROUND

As known, a unified TCI framework has been introduced to replace a TCI state or spatial relation framework for beam indication. Recently, it has been proposed to support a physical downlink shared channel (PDSCH) transmission in a coherent joint transmission (CJT) scheme. However, how to support a PDSCH transmission in a CJT scheme within a unified TCI framework is still unclear and needs to be further developed.

### SUMMARY

In general, example embodiments of the present disclosure provide methods, devices and computer storage media of communication in a unified TCI framework.

In a first aspect, there is provided a terminal device. The terminal device comprises a processor. The processor is configured to cause the terminal device to: receive downlink control information (DCI) scheduling a PDSCH transmission in a CJT scheme, the DCI indicating a set of TCI states; receive information of quasi co-location (QCL) parameter compensation for the PDSCH transmission; and receive the PDSCH transmission based on the set of TCI states and the information of QCL parameter compensation.

In a second aspect, there is provided a terminal device. The terminal device comprises a processor. The processor is configured to cause the terminal device to: receive DCI scheduling a PDSCH transmission in a CJT scheme, the DCI indicating a set of TCI states; and determine a TCI state in the set of TCI states for use in a further transmission, the further transmission being not performed in the CJT scheme while the PDSCH transmission is performed in the CJT scheme.

In a third aspect, there is provided a method of communication. The method comprises: receiving, at a terminal device, DCI scheduling a PDSCH transmission in a CJT scheme, the DCI indicating a set of TCI states; receiving information for QCL parameter compensation for the PDSCH transmission; and receiving the PDSCH transmission based on the set of TCI states and the information of QCL parameter compensation.

In a fourth aspect, there is provided a method of communication. The method comprises: receiving, at a terminal device, DCI scheduling a PDSCH transmission in a CJT scheme, the DCI indicating a set of TCI states; and determining a TCI state in the set of TCI states for use in a further transmission, the further transmission being not performed in the CJT scheme while the PDSCH transmission is performed in the CJT scheme.

In a fifth aspect, there is provided a computer readable medium having instructions stored thereon. The instructions, when executed on at least one processor, causing the at least one processor to perform the method according to the third or fourth aspect of the present disclosure.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which embodiments of the present disclosure can be implemented;

FIG. 2A illustrates a schematic diagram illustrating an issue in a network compensation based on reported channel state information (CSI) for a PDSCH transmission in a CJT scheme according to some example embodiments of the present disclosure;

FIG. 2B illustrates a schematic diagram illustrating an issue in other transmissions in case that a PDSCH transmission is performed in a CJT scheme according to some example embodiments of the present disclosure;

FIG. 3 illustrates a schematic diagram illustrating a process of communication for configuration of TCI for a PDSCH transmission in a CJT scheme according to some example embodiments of the present disclosure;

FIG. 4 illustrates a schematic diagram illustrating a process of communication for a PDSCH transmission in a CJT scheme according to some example embodiments of the present disclosure;

FIG. 5A illustrates a schematic diagram illustrating an example process of communication with a TRS as a QCL reference according to some example embodiments of the present disclosure;

FIG. 5B illustrates a schematic diagram illustrating an example process of communication with a CSI-RS for channel measurement as a QCL reference according to some example embodiments of the present disclosure;

FIG. 6 illustrates a schematic diagram illustrating a process of communication for determination of TCI for a transmission without CJT according to some example embodiments of the present disclosure;

FIG. 7 illustrates a flowchart of an example method performed by a terminal device in accordance with some embodiments of the present disclosure;

FIG. 8 illustrates a flowchart of another example method performed by a terminal device in accordance with some embodiments of the present disclosure; and

FIG. 9 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IOT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The network device may have the function of network energy saving, Self-Organizing Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As mentioned above, it is still unclear how to support a PDSCH transmission in a CJT scheme within a unified TCI framework. For example, it is unclear how to perform a PDSCH transmission in a CJT scheme within a unified TCI framework. It is also unclear how to perform other transmissions in case that a PDSCH transmission is performed in a CJT scheme.

In view of this, embodiments of the present disclosure provide solutions of communication so as to overcome the above or other potential issues. In one solution, a terminal device receives DCI scheduling a PDSCH transmission in a CJT scheme and indicating a set of TCI states, and receives information of QCL parameter compensation for the PDSCH transmission. Based on the set of TCI states and the information of QCL parameter compensation, the terminal device receives the PDSCH transmission. In this way, a PDSCH transmission in a CJT scheme may be performed correctly within a unified TCI framework.

In another solution, a terminal device receives DCI scheduling a PDSCH transmission in a CJT scheme and indicating a set of TCI states. The terminal device determines a TCI state in the set of TCI states for use in a further transmission, the further transmission being not performed in the CJT scheme while the PDSCH transmission is performed in the CJT scheme. In this way, uplink and downlink transmissions within a unified TCI framework may be enhanced.

Principles and implementations of the present disclosure will be described in detail below with reference to the figures.

In the present disclosure, some terms may refer to same or similar physical meaning and may be used interchangeably. Some exemplary examples are listed as below.
The term “tracking reference signal (TRS)” may be used interchangeably with “a NZP-CSI-RS-ResourceSet configured with higher layer parameter trs-Info” or “a CSI-RS resource in a NZP-CSI-RS-ResourceSet configured with higher layer parameter trs-Info”;
The term “CSI-RS for channel measurement” may be used interchangeably with “a CSI-RS resource in an NZP-CSI-RS-ResourceSet configured without higher layer parameter trs-Info and without the higher layer parameter repetition”;
The term “CSI-RS for beam measurement” can be used interchangeably with “a CSI-RS resource in an NZP-CSI-RS-ResourceSet configured with higher layer parameter repetition”;
The term “QCL” may refer to “two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters”;
The term “QCL parameters” may refer to “the large-scale properties includes one or more of delay spread, Doppler spread, Doppler shift, average gain, average delay, and spatial Rx parameters”;
The term “QCL reference for PDSCH, for PDCCH, for CSI-RS” may refer to “a quasi co-location relationship between one or two downlink reference signals and the DM-RS port(s) of the PDSCH, the DM-RS port(s) of PDCCH or the CSI-RS port(s) of a CSI-RS resource”;
The term “PDSCH CJT” may refer to “PDSCH transmitted in a CJT scheme”;
The term “PDCCH, PUCCH, PUSCH” may refer to “PDCCH, PUCCH, PUSCH transmission when PDSCH is transmitted in a CJT scheme”;
The term “DCI” may refer to “DCI format 1_1/1_2”, “DCI format 1_1/1_2 (with or without downlink (DL) assignment)”. As to DCI format 1_0 scheduling common PDSCH in most case, and it doesn't include a TCI field, scheduled PDSCH may only transmit in s-TRP mode.
The terms “precoder”, “precoding”, “precoding matrix”, “beam”, “spatial relation information”, “spatial relation info”, “precoding information”, “precoding information and number of layers”, “precoding matrix indicator (PMI)”, “precoding matrix indicator”, “transmission precoding matrix indication”, “precoding matrix indication”, “TCI state”, “transmission configuration indicator”, “quasi co-location (QCL)”, “quasi-co-location”, “QCL parameter”, “QCL assumption”, “QCL relationship” and “spatial relation” can be used interchangeably;
The terms “single TRP”, “single TCI state”, “single TCI”, “S-TCI”, “single control resource set (CORESET)”, “single CORESET pool”, “s-TRP” and “S-TCI state” can be used interchangeably;
The terms “multiple TRPs”, “multiple TCI states”, “multiple CORESETs” and “multiple control resource set pools”, “multi-TRP”, “multi-TCI state”, “multi-TCI”, “multi-CORESET” and “multi-control resource set pool”, “MTRP” and “M-TCI”, “M-TRP” can be used interchangeably;
The terms “resource(s)”, “resource(s) in a resource set”, “resource set” can be used interchangeably; and
The terms “group”, “subset”, “set” can be used interchangeably. The terms “transmit power”, “energy per resource element (EPRE)”, “linear average over the power contributions”, “average gain”, can be used interchangeably.
As used herein, the term “TRP” refers to an antenna array (with one or more antenna elements) available to the network device located at a specific geographical location. Although some embodiments of the present disclosure are described with reference to a scenario of multi-TRPs (or a scenario of single TRP) for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.
As used herein, the term “network”/“network device(s)” refers to one or more network devices. Accordingly, terms “network”, “network device(s)” and “one or more network devices” can be used interchangeably.
As used herein, QCL type(s) may comprise the following type(s):
   ‘typeA’: {Doppler shift, Doppler spread, average delay, delay spread};
   ‘typeB’: {Doppler shift, Doppler spread};
   ‘typeC’: {Doppler shift, average delay};
   ‘typeD’: {Spatial Rx parameter}.

### Example of Communication Environment

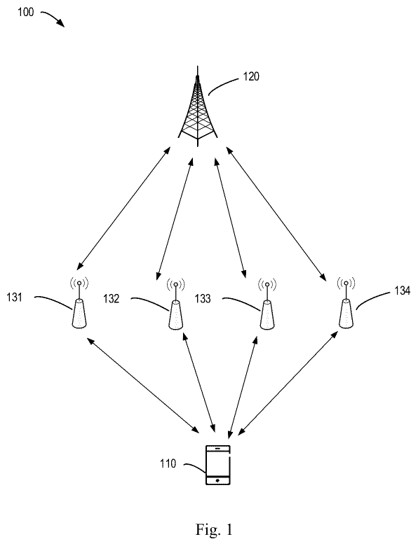

FIG. 1 illustrates an example communication network 100 in which embodiments of the present disclosure can be implemented. The communication network 100 includes a network device 120 and a terminal device 110. The network device 120 may be equipped with TRPs 131 to 134 and may provide services to the terminal device 110 via any of the TRPs 131 to 134.

In the communication network 100, a link from the network device 120 to the terminal device 110 is referred to as a downlink (DL), while a link from the terminal device 110 to the network device 120 is referred to as an uplink (UL).

Further, both a single TRP mode transmission and MTRP transmission may be supported by the specific example of FIG. 1. Specifically, in case of the single TRP mode, the terminal device 110 communicates with the network device 120 via one of the TRPs 131 to 134. Alternatively, in case of the MTRP mode, the terminal device 110 communicates with the network device 120 via two or more of the TRPs 131 to 134.

The communications in the communication network 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

It is to be understood that the number of network devices or terminal devices or TRPs in FIG. 1 is given for the purpose of illustration without suggesting any limitations to the present disclosure. The communication network 100 may include any suitable number of network devices and/or terminal devices and/TRPs adapted for implementing implementations of the present disclosure.

In some embodiments, the terminal device 110 may monitor a set of PDCCH candidates in one or more CORESETs on an active DL bandwidth part (BWP) on each activated serving cell configured with PDCCH monitoring according to corresponding search space sets where monitoring implies receiving each PDCCH candidate and decoding according to the monitored DCI formats.

In some embodiments, the network device 120 may transmit, to the terminal device 110, DCI indicating a joint unified TCI state. The joint unified TCI state provides a reference signal to determine QCL type and QCL reference signal. For UL, the unified TCI state also provide a transmitting (TX) beam, Uplink-powerControl and pathloss reference RS.

Recently, on unified TCI framework extension, it is agreed that up to 2 joint TCI states can be indicated and applied to CJT-based PDSCH reception. It is also agreed that a PDSCH transmission in a CJT scheme may be supported. Specifically, up to 4 TRPs may be used for the PDSCH transmission. The PDSCH transmission is a single-DCI based MTRP scheme. Up to 2 joint TCI states may be indicated for the PDSCH transmission. Other channels or signals such as PDCCH, PUCCH or PUSCH are not using the CJT scheme.

In this case, it is unclear how to use up to 2 TCI states to provide QCL information of 4 TRPs.

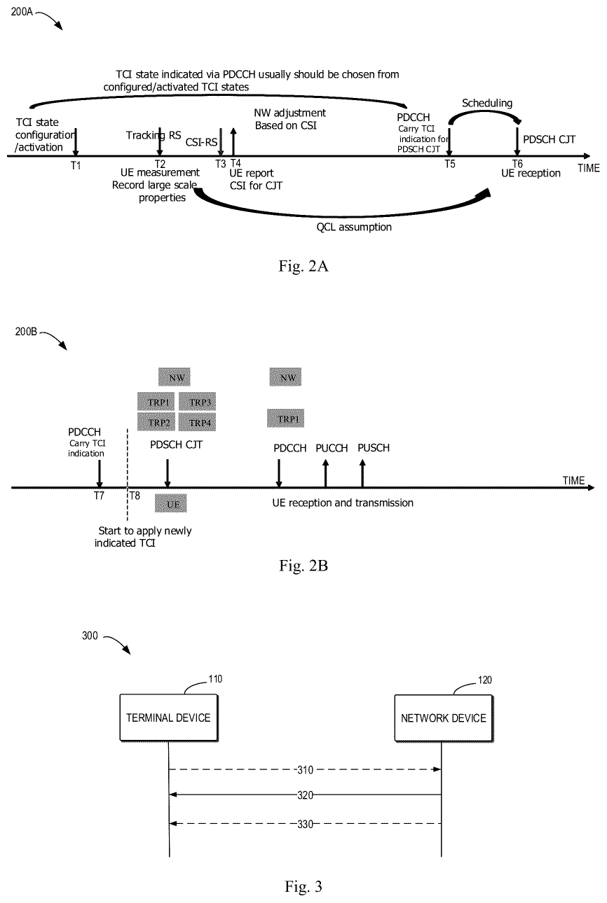

Further, an issue may occur in QCL assumption. FIG. 2A illustrates a schematic diagram 200A illustrating an issue in a network compensation based on reported CSI for a PDSCH transmission in a CJT scheme according to some example embodiments of the present disclosure. As shown in FIG. 2A, a set of TCI states is configured or activated for UE at a timing T1. UE may measure a set of TRSs and record large scale properties at a timing T2. Based on a set of CSI-RSs received from a network (NW) at a timing T3, UE may report CSI for PDSCH CJT at a timing T4. At a timing T5, UE may receive a scheduling for a PDSCH CJT via a PDCCH. The scheduling may indicate one or more TCI states for the PDSCH CJT. The one or more TCI states indicated via PDCCH usually are chosen from configured/activated TCI states. At a timing T6, UE receives the PDSCH CJT.

It can be seen that the network may perform compensation based on reported CJT CSI, which may change the large scale properties of followed PDSCH CJT. If UE only records those properties from latest measurement of reference signals, there may be some mismatch and PDSCH demodulation performance may be degraded. In worst case, PDSCH CJT may not be successful. In other words, if UE is not aware of network adjustment, UE may have a wrong or old or out-of-date QCL assumption.

More specifically, network compensation to support the PDSCH CJT is to fine-sync among multiple TRPs, e.g., align the initial phase of transmitted signals. It may be observed at UE side that network compensation may result in: time-domain and/or frequency-domain change of a signal; delay-domain and/or Doppler domain change of a signal; delay adjustment, phase rotation, Doppler shift, frequency adjustment of a signal.

In addition, an issue may also occur in other transmissions without using a CJT scheme. FIG. 2B illustrates a schematic diagram 200B illustrating an issue in other transmissions in case that a PDSCH transmission is performed in a CJT scheme according to some example embodiments of the present disclosure. As shown in FIG. 2B, at a timing T7, UE may receive a scheduling for a PDSCH CJT via a PDCCH. The scheduling may indicate one or more TCI states for the PDSCH CJT. At a timing T8, UE may start to apply the one or more TCI states indicated. However, UE performs a PDSCH reception from a network via TRP1, TRP2, TRP3 and TRP4. Further, UE performs a PDCCH reception or a PUCCH or PUSCH transmission via a TRP1.

A unified TCI framework is designed for a fast and low-overhead TCI update of PDCCH/PDSCH/PUCCH/PUSCH. A joint TCI state can also provide UL power control parameters and pathloss reference. However, only PDSCH can be transmitted in a CJT scheme. Up to two TCI states can be mapped to one TCI codepoint in DCI for PDSCH CJT. Those TCI states may not provide proper QCL information and/or power control information for PDCCH/PUCCH/PUSCH, as well as CSI-RS or SRS transmission.

In view of the above, embodiments of the present disclosure provide solutions of communication so as to overcome the above or other potential issues. These solutions will be described in detail below.

### Example Implementation of Configuration of TCI for PDSCH CJT

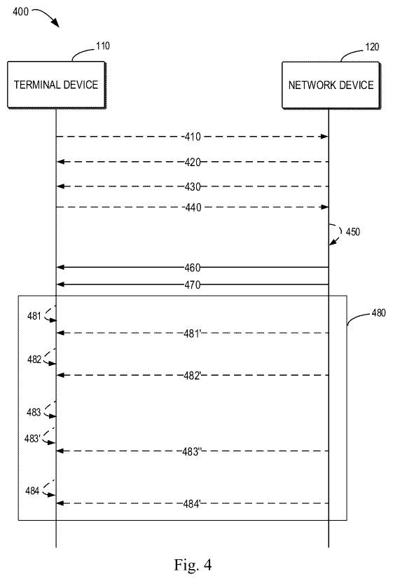

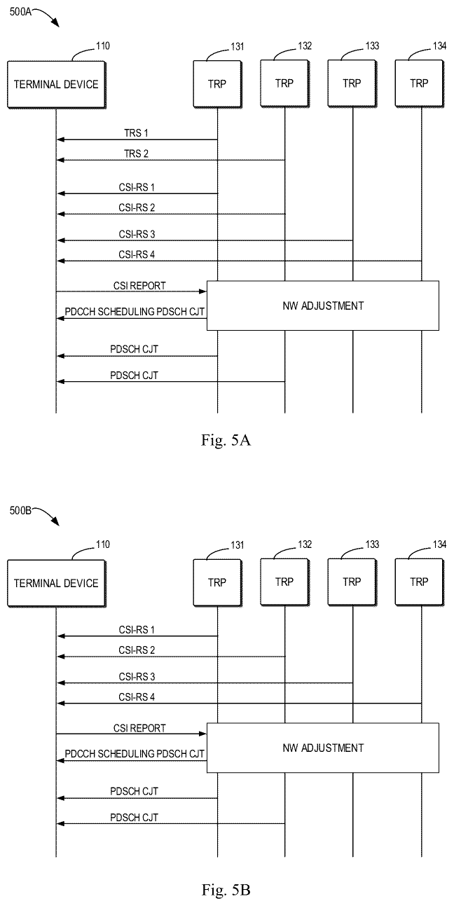

In this embodiment, a configuration of TCI for a PDSCH CJT is provided. The configuration of TCI will be described in connection with FIG. 3.

FIG. 3 illustrates a schematic diagram illustrating a process 300 of communication for configuration of TCI for PDSCH CJT according to some example embodiments of the present disclosure. For the purpose of discussion, the process 300 will be described with reference to FIG. 1.

With reference to FIG. 3, the terminal device 110 may transmit 310 information of UE capability to the network device 120. For example, the network device 120 may transmit, to the terminal device 110, a radio resource control (RRC) configuration regarding a UE capability reporting. The terminal device 110 may report capability of the terminal device 110 to the network device 120 based on the RRC configuration. In some embodiments, the UE capability reporting may comprise information about UE supports a PDSCH transmission in a CJT scheme. It is to be understood that any other suitable capability reporting is also feasible.

Based on the UE capability reporting, the network device 120 may transmit 320 a configuration of a PDSCH CJT transmission scheme to the terminal device 110. In some embodiments, the network device 120 may transmit the configuration via a RRC message. Alternatively or additionally, the network device 120 may use a medium access control control element (MAC CE) or DCI to enable the PDSCH CJT.

In some embodiments, the configuration may comprise a list of TCI states. In some embodiments, the TCI states in the list may be joint TCI states. In some embodiments, the TCI states in the list may be DL TCI states. In some embodiments, the TCI states in the list may be UL TCI states.

In some embodiments, the configuration may be associated with a bandwidth part (BWP) or component carrier (CC) or band. In some embodiments, the configuration may be associated with a group of BWPs or CCs or bands. In some embodiments, the configuration may be associated with a TRP or a group of TRPs.

In some embodiments, the list of TCI states may comprise only one TCI state. In example 1 for a QCL configuration, a TRS may be configured as a QCL reference signal, e.g., qcl-Type1: TRS1, type A. In example 2 for a QCL configuration, a CSI-RS for channel measurement (i.e., a CSI-RS resource or resource set) may be configured as a QCL reference signal, e.g., qcl-Type1: CSI-RS resource 1/CSI-RS resource set 1, type A. In example 3 for a QCL configuration, more than one TRS may be configured as QCL reference signals, e.g., qcl-Type1: TRS1, type A; qcl-Type2: TRS2, type B. In example 4 for a QCL configuration, more than one CSI-RS for channel measurement may be configured as QCL reference signals, e.g., qcl-Type1: CSI-RS resource 1/CSI-RS resource set 1, type A; qcl-Type2: CSI-RS resource 2/CSI-RS resource set 2, type B. For the above examples 2, 3 and 4, additional UE capability reporting is needed to inform a network whether UE can support such configurations.

In some embodiments where the list of TCI states may comprise only one TCI state, for a UL power control configuration, power control parameters may be configured for PUCCH, PUSCH and SRS transmissions for this TCI state. An identity (ID) of a reference signal (e.g., a CSI-RS configuration or a synchronization signal (SS) block) may be configured for PUSCH pathloss estimation for this TCI state.

In some embodiments, if no TCI state is configured, PDSCH CJT may also be supported in a UE transparent way. In some embodiments, if only one TCI state is configured, PDSCH CJT may be supported based on the one TCI state. In some embodiments, if only two TCI states are configured, PDSCH CJT may be supported based on these TCI states. In some embodiments, if more than two TCI states are configured, further selection via e.g., MAC CE or DCI may be needed to indicate up to 2 TCI states to UE.

In some embodiments, the network device 120 may configure a set of CSI-RS resources and a CSI report for PDSCH CJT. For example, the set of CSI-RS resources may comprise K_csi CSI-RS resources, e.g., K_csi≤M_trp, where M_trp denotes the number of TRPs selected by the terminal device 110 for CJT. In some example, M_trp≤N_trp, where N_trp denotes the number of TRPs used for CSI CJT report. Selection of M_trp out of N_trp can be reported with a bitmap with length N_trp. In some example, K_csi=N_trp.

In some embodiments, the network device 120 may configure a set of TRSs. For example, the set of TRSs may comprise M_trs TRSs, e.g., M_trs≤N_trp, where N_trp denotes the number of TRPs used for CSI CJT report. M_trs TRSs may be transmitted from each TRP respectively. The terminal device 110 may measure each TRS and obtain a set of QCL parameters for each TRP. In some example, M_trs=1, and it is transmitted jointly from multiple TRPs, then the multiple TRPs are transparent to the terminal device 110, the terminal device 110 may measure this TRS and obtain QCL parameters for an equivalent transmission point, or a virtual transmission point. In some example, one of TRS may be a reference TRS, and it is transmitted from reference TRP.

Optionally, the network device 120 may configure the number and/or the maximum number of TCI states that can be mapped to one TCI codepoint, for example, based on the UE capability reporting, e.g., {1,2}, or {1,2,3,4}. In some embodiments, the number and/or the maximum number of TCI states may be not greater than the number of K_csi CSI-RS resources for CJT CSI report, or the number of N_trp={1, 2, 3, 4} cooperating TRPs for CJT CSI report.

In some embodiments, for each cell/BWP configured with PDSCH CJT, the number and/or the maximum number of TCI states that can be mapped to one TCI codepoint may be configured separately. In some embodiments, for each cell/BWP configured with PDSCH CJT, the number and/or the maximum number of TCI states that can be mapped to one TCI codepoint may be configured to be the same. In some embodiments, for each configured CORESET, the number and/or the maximum number of TCI states that can be mapped to one TCI codepoint may be configured separately. In some embodiments, for each configured CORESET, except CORESET 0, the number and/or the maximum number of TCI states that can be mapped to one TCI codepoint may be configured to be the same.

Continue to refer to FIG. 3, the network device 120 may transmit 330, to the terminal device 110, a MAC CE activating a subset of TCI states in the list of TCI states. The MAC CE may also provide a mapping between TCI states and a TCI codepoint in DCI.

In some embodiments, TRSs corresponding to activated TCI states may be considered as activated. In some embodiments, if one TCI state is mapped to the TCI codepoint in DCI for PDSCH CJT, the terminal device 110 may measure a DL RS of this TCI state and obtain QCL parameters for an equivalent or virtual transmission point.

In some embodiments, two TCI states may be mapped to one TCI codepoint in DCI for the PDSCH transmission. In this case, the first TCI state may provide reference information for the PDSCH transmission and the second TCI state provides additional information for the PDSCH transmission different from the reference information.

In some embodiments, the additional information may comprise at least one of the following: an average delay; a delay spread; a Doppler shift; a Doppler spread; a phase parameter; or a transmitting power parameter. In some embodiments, the average delay may comprise a maximum average delay of the PDSCH transmission. In some embodiments, the delay spread may comprise a maximum delay spread of the PDSCH transmission. In some embodiments, the phase parameter may comprise absolute phase, initial phase, phase shift, phase rotation. In some embodiments, the transmitting power parameter may comprise transmitting power or a power offset.

In some embodiments, DL RSs of the two TCI states may be configured or transmitted with the same transmit power or the same power offset to a reference transmit power, for example, they may be configured with the same value for the parameter powerControlOffsetSS.

In some embodiments, the two TCI states may provide two different values for a parameter, and the terminal device may assume the applied value(s) of the parameter is the maximum, the minimum, the average, or the weighted average of the two values. For example, the first TCI state is associated with a first delay, and the second TCI state is associated with a second delay. In this case, the terminal device 110 may assume that delay applied for PDSCH CJT is the maximum or the first and the second delay. In another example, the first TCI state is associated with a first Doppler, and the second TCI state is associated with a second Doppler. In this case, the terminal device 110 may assume that Doppler applied for PDSCH CJT is the average or the first and the second delay. In addition, the terminal device 110 may assume that the applied value(s) of the parameter is the one associated with the first TCI state or the second TCI state.

In some alternative embodiments, if one TCI state can provide two QCL reference signals, 2 TCI states can provide 4 QCL reference signal. For example, TCI state 1 provides qcl-Type1: TRS 1 or CSI-RS resource 1, type A; and qcl-Type2: TRS 2 or CSI-RS resource 2, type A/B/C. TCI state 2 provides qcl-Type1: TRS 3 or CSI-RS resource 3, type A; and qcl-Type2: TRS4 or CSI-RS resource 4, type A/B/C.

With the process 300, up to 2 TCI states may be used to provide QCL information of 4 TRPs, and thus a correct QCL assumption may be provided to a terminal device.

### Example Implementation of PDSCH CJT within Unified TCI Framework

In this embodiment, a solution of a PDSCH transmission in a CJT scheme is provided. This solution will be described in connection with FIG. 4.

FIG. 4 illustrates a schematic diagram illustrating a process 400 of communication for a PDSCH transmission in a CJT scheme according to some example embodiments of the present disclosure. For the purpose of discussion, the process 400 will be described with reference to FIG. 1.

As shown in FIG. 4, the terminal device 110 may report 410, to the network device 120, capability of the terminal device 110. In some embodiments, the capability of the terminal device 110 may comprise information of support for QCL parameter compensation. For example, the capability of the terminal device 110 may comprise an indication indicating whether the terminal device 110 can support compensation on one or more QCL parameters. In another example, the capability of the terminal device 110 may comprise information of a range of the QCL parameter compensation that the terminal device 110 can support. In another example, the capability of the terminal device 110 may comprise an indication indicating whether the terminal device 110 can support using only indicated TCI states (i.e., old QCL parameter) to demodulate PDSCH CJT.

In some embodiments, the capability of the terminal device 110 may comprise a time duration for the QCL parameter compensation. For example, the capability of the terminal device 110 may comprise a time duration the terminal device 110 can obtain new QCL parameters based on the QCL parameter compensation. In another example, the capability of the terminal device 110 may comprise a time duration the terminal device 110 can apply the QCL parameter compensation. In still another example, the capability of the terminal device 110 may comprise a time duration the terminal device 110 can apply the indicated TCI state with the QCL parameter compensation. It is to be understood that any combination of the above information is also feasible.

Continue to refer to FIG. 4, the network device 120 may transmit 420 a reference signal (for convenience, also referred to as a first reference signal herein) as a QCL reference. In some embodiments, the first reference signal may be explicitly configured as QCL reference in TCI state. In some embodiments, the first reference signal may be implicitly determined. In some embodiments, the first reference signal may be a TRS. In some embodiments, the first reference signal may be a CSI-RS for channel measurement.

With reference to FIG. 4, the network device 120 may transmit 430, to the terminal device 110, a CSI-RS for channel or interference measurement. In an example, K_csi CSI-RSs may be transmitted from N_trp TRPs. In another example, one CSI-RS may be transmitted repeatedly from N_trp TRPs.

Based on a measurement on the CSI-RS, the terminal device 110 may report 440, to the network device 120, CSI for PDSCH CJT. For example, a Type-II codebook and its refinement may be reported. In another example, strongest coefficient indicator (SCI) may be reported. The SCI may be applied across all N CSI-RS resources and may be used to determine a reference TRP. In still another example, selection of M_trp CSI-RS resources out of K_csi CSI-RS resources or N_trp TRPs may be reported. The selection of M_trp CSI-RS resources may be not reported if M_trp=N_trp is configured as restriction by a network.

Based on the reported CSI, the network device 120 may perform 450 an adjustment on PDSCH CJT. For example, the network device 120 may determine a number of TRPs used for PDSCH CJT, and perform a fine synchronization between TRPs to adjust signals transmitted coherently from different TRPs. Compensation may be an adjustment method in time-domain and/or frequency-domain. Compensation may be an adjustment method in one or more of average delay, delay spread, Doppler shift and Doppler spread (in other words, QCL type A/B/C/D parameters). Compensation may be an adjustment method in one or more of phase shift and frequency shift. Compensation may be an adjustment method in transmitting power. It is to be understood that these merely are examples and the network adjustment may be dependent on a network implementation.

Continue to refer to FIG. 4, the network device 120 may transmit 460 DCI scheduling a PDSCH CJT via a PDCCH. The DCI indicates a set of TCI states. In some embodiments, the DCI may comprise a TCI field to inform the terminal device 110 about QCL assumption for PDSCH reception. The TCI field may comprise a number of TRPs for PDSCH CJT. It is to be understood that the TCI field is optional.

With reference to FIG. 4, the network device 120 may transmit 470, to the terminal device 110, information of QCL parameter compensation for PDSCH CJT. In some embodiments, the network device 120 may cause the information of QCL parameter compensation to be comprised in the DCI. In this case, the terminal device 110 may obtain the information of QCL parameter compensation from the DCI. It is to be understood that the information of QCL parameter compensation may be transmitted separately from DCI.

In some embodiments, the information of QCL parameter compensation may comprise compensation for a time-domain parameter. In some embodiments, the information of QCL parameter compensation may comprise compensation for a frequency-domain parameter such as frequency value or frequency shift. In some embodiments, the information of QCL parameter compensation may comprise compensation for a phase parameter such as a phase value or a phase shift. In some embodiments, the information of QCL parameter compensation may comprise compensation for a delay parameter such as an average delay or delay spread. In some embodiments, the information of QCL parameter compensation may comprise compensation for a Doppler parameter such as Doppler shift or Doppler spread. In some embodiments, the information of QCL parameter compensation may comprise compensation for transmitting power.

In some embodiments, the information of QCL parameter compensation may comprise an indication indicating whether the QCL parameter compensation is applied. In some embodiments, the indication may comprise an exact value of the applied compensation. For example, for a delay parameter, the indication may comprise X μs. For a Doppler parameter, the indication may comprise X Hz. For a phase parameter, the indication may comprise X degree. For a power parameter, the indication may comprise X dB. In some embodiments, the indication may be signaled per TCI state. In some embodiments, the reference TRP may not need to apply any compensation.

In some embodiments where two TCI states are mapped to one TCI codepoint in the DCI, the information of the QCL parameter compensation may be provided via the second TCI state.

Based on the set of TCI states and the information of QCL parameter compensation, the terminal device 110 may receive 480 the PDSCH CJT.

In some embodiments, the terminal device 110 may receive the set of first reference signals based on the set of TCI states, and determine 481 a set of QCL parameters (for convenience, also referred to as a first set of QCL parameters herein) based on a measurement (for convenience, also referred to as a first measurement herein) on the set of first reference signals. Then the terminal device 110 may receive 481′ the PDSCH CJT based on the first set of QCL parameters and the information of QCL parameter compensation. In some embodiments, the terminal device 110 may determine 482 another set of QCL parameters (for convenience, also referred to as a second set of QCL parameters herein) by modifying the first set of QCL parameters based on the information of QCL parameter compensation, and receive 482′ the PDSCH transmission based on the second set of QCL parameters. For example, if a detailed value has been indicated as the information of QCL parameter compensation, the terminal device 110 may apply those values to the previous measurement results (i.e., the first measurement) on the first reference signals, for example, with scaling or an offset. In this way, the QCL parameters may be adjusted based on the previous measurement results.

Alternatively, the terminal device 110 may ignore the previous measurement results, and use additional reference signal measurements to update the set of QCL parameters. In some embodiments, the terminal device 110 may receive 483 another set of reference signals (for convenience, also referred to as a set of second reference signals herein) based on the set of TCI states, and determine 483′ a third set of QCL parameters based on a second measurement on the set of second reference signals. Then the terminal device 110 may receive 483″ the PDSCH transmission based on the third set of QCL parameters.

Alternatively or additionally, the terminal device 110 may receive the PDSCH transmission based on the third set of QCL parameters and the information of QCL parameter compensation. In some embodiments, the terminal device 110 may modify 484 the third set of QCL parameters with the information of QCL parameter compensation, and receive 484′ the PDSCH transmission based on the modified set of QCL parameters.

In some embodiments, the set of second reference signals may comprise a set of demodulation reference signals (DMRSs) of the PDSCH transmission. In some embodiments, the terminal device 110 may measure the set of DMRSs and obtain the third set of QCL parameters only based on the measurements on the set of DMRSs.

In some embodiments, the set of second reference signals may comprise a further set of the first reference signals, i.e., another transmission occasion of the first reference signals if they are periodic or semi-persistent.

In some embodiments, the set of second reference signals may comprise a set of reference signals (for convenience, also referred to as a set of third reference signals herein) associated with the set of first reference signals. In some embodiments where the set of first reference signals is a set of periodic TRSs, the set of third reference signals may be a set of aperiodic TRSs. In some embodiments, the set of TCI states may be applied to PDSCH CJT after the latest additional reference signals transmission after DCI reception.

In some embodiments, the terminal device 110 may receive the PDSCH transmission by applying the set of TCI states and the information of QCL parameter compensation after a time duration from reception of the DCI. In some embodiments, the terminal device 110 may receive the PDSCH transmission by applying the set of TCI states and the information of QCL parameter compensation after a time duration from transmission of acknowledgement for the reception of the DCI. The time duration may be reported as capability of the terminal device 110.

With the process 400, a PDSCH transmission in a CJT scheme may be supported within a unified TCI framework.

For illustration, some example embodiments will be described with reference to FIGS. 5A and 5B. FIG. 5A illustrates a schematic diagram illustrating an example process 500A of communication with a TRS as a QCL reference according to some example embodiments of the present disclosure. For the purpose of discussion, the process 500A will be described with reference to FIG. 1.

As shown in FIG. 5A, the terminal device 110 may receive TRS 1 from TRP 131 and TRS 2 from TRP 132 as QCL reference. The terminal device 110 may receive CSI-RS 1 from TRP 131, CSI-RS 2 from TRP 132, CSI-RS 3 from TRP 133 and CSI-RS 4 from TRP 134. The terminal device 110 may transmit a CSI report to the network device 120. The network device 120 may perform network adjustment. In this example, it is assumed that additional adjustment for TRP 132 is performed in average delay, phase, Doppler shift or frequency shift. The network device 120 may decide to use TRPs 131 and 132 to perform PDSCH CJT. The network device 120 may transmit, to the terminal device 110, a PDCCH scheduling PDSCH CJT and transmit PDSCH CJT via the TRPs 131 and 132.

In a modification to the above example of FIG. 5A, if TRP 131 and TRP 133 are used for CJT, additional RS may be TRS 3 for TRP 133, and the network device 120 may need to activate a TCI state for TRP 133 and deactivate a TCI sate for TRP 132.

FIG. 5B illustrates a schematic diagram illustrating an example process 500B of communication with a CSI-RS for channel measurement as a QCL reference according to some example embodiments of the present disclosure. For the purpose of discussion, the process 500B will be described with reference to FIG. 1.

As shown in FIG. 5B, the terminal device 110 may receive CSI-RS 1 from TRP 131 and CSI-RS 2 from TRP 132 as QCL reference and for channel measurement. The terminal device 110 may also receive CSI-RS 3 from TRP 133 and CSI-RS 4 from TRP 134 for channel measurement. The terminal device 110 may transmit a CSI report to the network device 120. The network device 120 may perform network adjustment. In this example, it is assumed that additional adjustment for TRP 132 is performed in average delay, phase, Doppler shift or frequency shift. The network device 120 may decide to use TRPs 131 and 132 to perform PDSCH CJT. The network device 120 may transmit, to the terminal device 110, a PDCCH scheduling PDSCH CJT and transmit PDSCH CJT via the TRPs 131 and 132.

In a modification to the above example of FIG. 5B, if TRP 131 and TRP 133 are used for CJT, additional RS may be TRS 3 for TRP 133, and the network device 120 may need to activate a TCI state for TRP 133 and deactivate a TCI sate for TRP 132.

### Example Implementation of Other Transmissions within Unified TCI Framework

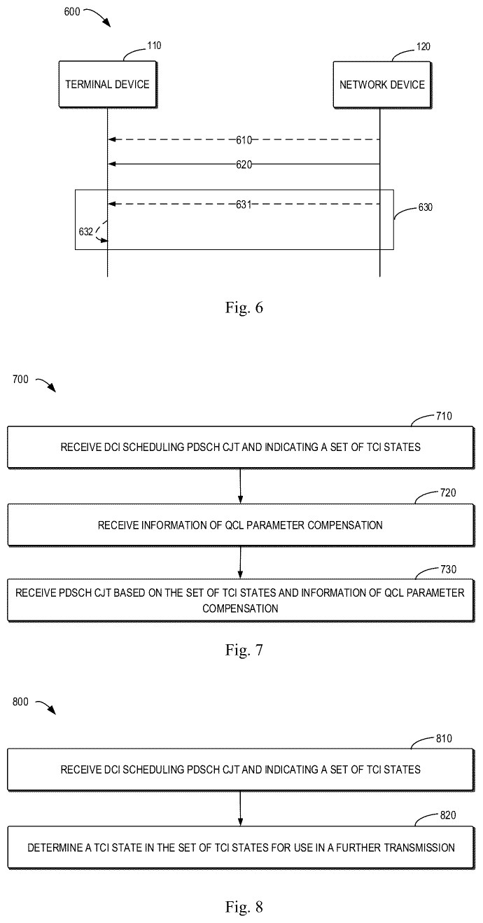

In this embodiment, a solution of a TCI state determination is provided for a transmission without CJT. This solution will be described in connection with FIG. 6.

FIG. 6 illustrates a schematic diagram illustrating a process 600 of communication for determination of TCI for a transmission without CJT according to some example embodiments of the present disclosure. For the purpose of discussion, the process 600 will be described with reference to FIG. 1.

As shown in FIG. 6, the network device 120 may transmit 610, to the terminal device 110, a configuration of TCI for PDSCH CJT. In some embodiments where two TCI states are indicated, the configuration may indicate that a first TCI state provides reference information for the PDSCH CJT and a second TCI state provides additional information for the PDSCH CJT different from the reference information.

In some embodiments, the additional information may comprise at least one of the following: an average delay; a delay spread; a Doppler shift; a Doppler spread; a phase parameter; or a transmitting power parameter. In some embodiments, the average delay may comprise a maximum average delay of the PDSCH CJT. In some embodiments, the delay spread may comprise a maximum delay spread of the PDSCH CJT. In some embodiments, the phase parameter may comprise at least one of a phase value, an initial phase, a phase shift or a phase rotation. In some embodiments, the transmitting power parameter may comprise at least one of a power value or a power offset.

Other details of the configuration of TCI for PDSCH CJT are similar to that described in connection with FIG. 3, and thus are not repeated here for concise.

Continue to refer to FIG. 6, the network device 120 may transmit 620, to the terminal device 110, DCI scheduling a PDSCH CJT via a PDCCH. The DCI indicates a set of TCI states. The operations of the step 610 are similar to that of the step 460 in FIG. 4 and thus are not repeated here for concise.

The terminal device 110 may determine 630 a TCI state in the set of TCI states for use in a further transmission. The further transmission is not performed in a CJT scheme while a PDSCH transmission is performed in a CJT scheme.

In some embodiments, the further transmission may comprise a PDCCH transmission. In some embodiments, the further transmission may comprise a CSI-RS transmission. In some embodiments, the further transmission may comprise a CSI-RS transmission on a same time-domain location as the PDSCH CJT. In some embodiments, the further transmission may comprise a PUCCH transmission. In some embodiments, the further transmission may comprise a PUSCH transmission. In some embodiments, the further transmission may comprise a SRS transmission.

In some embodiments, the terminal device 110 may receive 631, from the network device 120, an indication of the TCI state configured for the further transmission. In this way, a TCI state for the further transmission may be decoupled from TCI states for PDSCH CJT. In other words, TCI states for PDSCH CJT do not apply to the further transmission.

In some embodiments, the terminal device 110 may determine 632, as the TCI state, a predetermined TCI state in the set of TCI states. In this way, a TCI state for the further transmission may be at least partially associated with TCI states for PDSCH CJT. In some embodiments, the terminal device 110 may determine, as the predetermined TCI state, a TCI state configured as providing reference information for the PDSCH CJT. In some embodiments, the terminal device 110 may determine, as the predetermined TCI state, a TCI state providing a downlink reference signal with a lowest pathloss in the set of TCI states.

In some embodiments, the terminal device 110 may receive information of QCL parameter compensation for the PDSCH CJT. The operations of reception of the information of QCL parameter compensation are similar to that described in FIG. 3, and thus are not repeated here for concise. In these embodiments, the terminal device 110 may cause the information of QCL parameter compensation to be not applied to the further transmission.

For illustration, some example embodiments will be described in connection with Embodiments 1 to 3 below.

### Embodiment 1

In this embodiment, if multiple joint TCI states are indicated for PDSCH CJT, for PDCCH reception, the QCL assumption may be based on one of the indicated TCI states for PDSCH CJT. The compensation applied to PDSCH CJT does not apply to PDCCH.

In some embodiments, PDCCH reception may be decoupled from TCI states for PDSCH CJT. In other words, the set of TCI states indicated for PDSCH CJT does not apply to PDCCH reception. In some embodiments, if CJT is enabled, a RRC configuration may be used to inform that the terminal device 110 may apply none of the indicated TCI states to a CORESET. In some embodiments, the terminal device 110 assumes that the TCI state(s) or the QCL assumption(s) for the PDSCH CJT is not identical to the TCI state(s) or QCL assumption(s) whichever is applied for the CORESET used for the reception of the DL DCI, regardless of RRC configuration. In some embodiments, the terminal device 110 may expect a dedicated, configured or indicated TCI state for PDCCH. In some embodiments, the terminal device 110 may report capability of the terminal device 110 to the network device 120, comprising information about that the terminal device supports an additional TCI state configuration for PDCCH reception.

In some embodiments, PDCCH reception may be at least partially associated with TCI states for PDSCH CJT. In other words, the set of TCI states indicated for PDSCH CJT can be applied to PDCCH reception. In some embodiments where the terminal device 110 is provided with additional information, a RRC configuration may be used to inform that the terminal device 110 may apply one of the indicated TCI states to a CORESET. For example, the one of the indicated TCI states may be the first one or the second one of the indicated joint TCI states. In some embodiments, the terminal device 110 may report capability of the terminal device 110 to the network device 120, comprising information about the terminal device supporting that a TCI state configuration for PDSCH CJT can be also used for PDCCH reception.

In some embodiments, some rules may be defined. For example, PDCCH is always transmitted from the reference/strongest TRP. In other words, it is assumed that QCL according to TCI state corresponds to reference/strongest TRP. In another example, PDCCH is always transmitted with QCL assumptions of the first indicated joint TCI states, if more than one TCI state is indicated for PDSCH CJT. In still another example, the terminal device 110 may apply the first one of two TCI states corresponding to the lowest TCI codepoint among those mapped to two TCI states and applicable to the PDSCH.

In some embodiments where there are two TCI states, one TCI state or no TCI indication for PDSCH CJT, if network compensation is applied to PDSCH CJT, the compensation does not apply to PDCCH and PDCCH is always transmitted without compensation. For example, the terminal device 110 may use the original/old QCL assumption configured/indicated for PDSCH CJT for PDCCH reception.

In some embodiments, a ratio of PDCCH energy per resource element (EPRE) to CSI-RS EPRE is assumed as 0 dB, where the CSI-RS is configured as QCL reference in the TCI state(s) corresponds to reference/strongest TRP or the first indicated joint TCI states, if more than one TCI state is indicated for PDSCH CJT.

In some embodiments, a ratio of PDCCH EPRE to CSI-RS EPRE is indicated by the network device 120, where the CSI-RS is configured as QCL reference in the TCI state(s) corresponds to reference/strongest TRP or the first indicated joint TCI states, if more than one TCI state is indicated for PDSCH CJT.

In some embodiments, a ratio of PDCCH EPRE to CSI-RS EPRE is related to the power offset between a dedicated DL-RS configured as QCL reference in the TCI state(s) for PDCCH and the CSI-RS configured as QCL reference in the TCI state(s) corresponds to reference/strongest TRP or the first indicated joint TCI states, if more than one TCI state is indicated for PDSCH CJT.

In this way, a correct QCL assumption may be provided for PDCCH.

### Embodiment 2

In this embodiment, for CSI-RS transmitted on the same OFDM symbol as PDSCH CJT with two TCI states enabled, the QCL assumption can be based on one of the indicated TCI states for PDSCH CJT, and the compensation does not apply to CSI-RS measurement.

In some embodiments, the CSI-RS may be aperiodic CSI-RS resource in a CSI-RS resource set associated with a CSI triggering state. In some embodiments, the CSI-RS may be periodic or semi-persistent CSI-RS. In some embodiments, other signals such as other CSI-RSs may also be transmitted on the same OFDM symbol as PDSCH CJT and the CSI-RS.

In some embodiments, CSI-RS measurement may be decoupled from TCI states for PDSCH CJT. In other words, the set of TCI states indicated for PDSCH CJT does not apply to CSI-RS measurement. In some embodiments, if CJT is enabled, a RRC configuration may be used to inform that the terminal device 110 may apply none of the indicated TCI states to a CSI-RS resource or resource set. In some embodiments, the terminal device 110 assumes that the TCI state(s) or the QCL assumption(s) for the PDSCH CJT is not identical to the TCI state(s) or QCL assumption(s) whichever is applied for the CORESET used for the reception of the DL DCI, regardless of RRC configuration. In some embodiments, the terminal device 110 may expect that QCL information is dedicatedly present for CSI-RS. In some embodiments, the terminal device 110 may report capability of the terminal device 110 to the network device 120, comprising information about that the terminal device supports an additional QCL information for CSI-RS on the same symbol.

In some embodiments, CSI-RS measurement may be at least partially associated with TCI states for PDSCH CJT on the same OFDM symbol. In other words, the set of TCI states indicated for PDSCH CJT can be applied to CSI-RS on the same symbol. In some embodiments where the terminal device 110 is provided with additional information, a RRC configuration may be used to inform that the terminal device 110 may apply one of the indicated TCI states to a CORESET. For example, the one of the indicated TCI states may be the first one or the second one of the indicated joint TCI states. In some embodiments, the terminal device 110 may report capability of the terminal device 110 to the network device 120, comprising information about the terminal device supporting that a TCI state configuration for PDSCH CJT can be also used for CSI-RS on the same symbol.

In some embodiments, some rules may be defined. For example, it is assumed to use QCL of the reference/strongest TRP previously reported by the terminal device 110. In another example, it may be always assumed to use the first indicated joint TCI states if more than one indicated TCI states for PDSCH CJT. In still another example, the terminal device 110 may apply the first one of two TCI states corresponding to the lowest TCI codepoint among those mapped to two TCI states and applicable to the PDSCH.

In some embodiments where there are two TCI states, one TCI state or no TCI indication for PDSCH CJT, if network compensation is applied to PDSCH CJT, the compensation does not apply to CSI-RS measurement. For example, the terminal device 110 may use the original/old QCL assumption configured/indicated for PDSCH CJT for CSI-RS measurement. In some alternative embodiments, the compensation may also apply to CSI-RS measurement. In this case, the terminal device 110 may need to report, in a CSI report, that the compensation is applied.

In this way, a correct QCL assumption may be provided for CSI-RS measurement.

### Embodiment 3

In this embodiment, if multiple joint TCI states are indicated for PDSCH CJT, for UL transmission, the transmit power may be determined based on a TCI state providing DL RS with a smallest pathloss among the set of TCI states. In some embodiments, the UL transmission may be a PUSCH, PUCCH or SRS. It is assumed that two TCI states are mapped to one TCI codepoint in DCI for PDSCH CJT.

In some embodiments, the UL transmission may be decoupled from TCI states for PDSCH CJT. In other words, the set of TCI states indicated for PDSCH CJT does not provide power control parameters and/or pathloss reference signal information for PUSCH or PUCCH or SRS transmission. In some embodiments, if CJT is enabled, a RRC configuration may be used to inform that the terminal device 110 may apply none of the indicated TCI states to a PUSCH transmission or SRS resource configured for codebook or non-codebook based PUSCH transmission. In some embodiments, the terminal device 110 may expect a dedicated power control parameter and/or pathloss reference signal information configured for PUCCH or PUSCH or SRS respectively or jointly. In some embodiments, the terminal device 110 may report capability of the terminal device 110 to the network device 120, comprising information about that the terminal device supports additional power control parameters and/or pathloss reference signal information for PUCCH, PUSCH or SRS respectively or jointly.

In some embodiments, UL transmission may be at least partially associated with TCI states for PDSCH CJT. In other words, the set of TCI states indicated for PDSCH CJT can provide power control parameters and/or pathloss reference signal information for PUSCH or PUCCH or SRS transmission. In some embodiments where the terminal device 110 is provided with additional information, a RRC configuration may be used to inform that the terminal device 110 may apply the power control parameters and/or pathloss reference signal information associated with one of the indicated TCI states to a PUSCH or PUCCH or SRS transmission. For example, the one of the indicated TCI states may be the first one or the second one of the indicated joint TCI states.

In some embodiments, some rules may be defined. For example, PUSCH or PUCCH or SRS transmitting power is always determined based on the TCI state providing DL RS with a smallest pathloss. In other words, it is suggested that the transmitting power is determined based on the TCI state corresponding to reference or nearest or strongest TRP. The power control parameter setting and pathloss may result in a smallest transmitting power. In another example, PUSCH or PUCCH or SRS transmitting power is always transmitted with power control parameters associated with the first indicated joint TCI states. In some embodiments, the terminal device 110 may report capability of the terminal device 110 to the network device 120, comprising information about the terminal device supporting that a TCI state configuration for PDSCH CJT can be also used for determining power control parameters and/or pathloss reference signal information for PUCCH, PUSCH or SRS respectively or jointly.

In some embodiments, if network compensation is applied to PDSCH CJT (in this case, the most possible example is that the network device 120 compensates for DL Tx power). The compensation does not apply to pathloss measurement, and the compensation does not apply to UL power compensation.

In this way, a correct power control parameter may be provided for a terminal device.

With the process 600, other transmissions may also be performed correctly while a PDSCH is performed in a CJT scheme. It is to be understood that the above processes 300 to 600 may be carried out separately or in any suitable combination.

### Example Implementation of Methods

Accordingly, embodiments of the present disclosure provide methods of communication implemented at a terminal device and a network device. These methods will be described below with reference to FIGS. 7 to 8.

FIG. 7 illustrates an example method 700 of communication implemented at a terminal device in accordance with some embodiments of the present disclosure. For example, the method 700 may be performed at the terminal device 110 as shown in FIG. 1. For the purpose of discussion, the method 700 will be described with reference to FIG. 1. It is to be understood that the method 700 may include additional blocks not shown and/or may omit some blocks as shown, and the scope of the present disclosure is not limited in this regard.

At block 710, the terminal device 110 receives DCI scheduling a PDSCH transmission in a CJT scheme. The DCI indicates a set of TCI states.

At block 720, the terminal device 110 receives information of QCL parameter compensation for the PDSCH transmission. In some embodiments, the DCI may comprise the information of QCL parameter compensation. In this case, the terminal device may obtain the information of QCL parameter compensation from the DCI.

In some embodiments, the information of QCL parameter compensation comprises at least one of the following: compensation for a time-domain parameter; compensation for a frequency-domain parameter; compensation for a phase parameter; compensation for a delay parameter; compensation for a Doppler parameter; compensation for transmitting power; or an indication indicating whether the QCL parameter compensation is applied.

At block 730, the terminal device 110 receives the PDSCH transmission based on the set of TCI states and the information of QCL parameter compensation.

In some embodiments, the terminal device 110 may receive a set of first reference signals based on the set of TCI states, and determine a first set of QCL parameters based on a first measurement on the set of first reference signals. The terminal device 110 may receive the PDSCH transmission based on the first set of QCL parameters and the information of QCL parameter compensation. In some embodiments, the terminal device 110 may determine a second set of QCL parameters by modifying the first set of QCL parameters based on the information of QCL parameter compensation, and receive the PDSCH transmission based on the second set of QCL parameters.

In some embodiments, a set of first reference signals is received based on the set of TCI states at a first timing. In these embodiments, the terminal device 110 may receive a set of second reference signals based on the set of TCI states at a second timing later than the first timing, and determines a third set of QCL parameters based on a second measurement on the set of second reference signals. The terminal device 110 may receive the PDSCH transmission based on the third set of QCL parameters.

In some embodiments, a set of first reference signals is received based on the set of TCI states at a first timing. In these embodiments, the terminal device 110 may receive a set of second reference signals based on the set of TCI states at a second timing later than the first timing and determine a third set of QCL parameters based on a second measurement on the set of second reference signals. Then the terminal device 110 may receive the PDSCH transmission based on the third set of QCL parameters and the information of QCL parameter compensation.

In some embodiments, the terminal device 110 may ignore a first measurement on the set of first reference signals.

In some embodiments, the set of second reference signals may comprise one of the following: a set of DMRSs of the PDSCH transmission; a further set of first reference signals; or a set of third reference signals associated with the set of first reference signals.

In some embodiments, the first reference signals may be TRSs. In some embodiments, the first reference signals may be CSI-RSs.

In some embodiments, the terminal device 110 may report capability of the terminal device 110, the capability comprising at least one of the following: information of support for the QCL parameter compensation; or a time duration for the QCL parameter compensation.

In some embodiments, the terminal device 110 may receive the PDSCH transmission by applying the set of TCI states and the information of QCL parameter compensation after a time duration from reception of the DCI.

With the method 700, a PDSCH transmission in a CJT scheme may be well supported within a unified TCI framework.

FIG. 8 illustrates another example method 800 of communication implemented at a terminal device in accordance with some embodiments of the present disclosure. For example, the method 800 may be performed at the terminal device 110 as shown in FIG. 1. For the purpose of discussion, the method 800 will be described with reference to FIG. 1. It is to be understood that the method 800 may include additional blocks not shown and/or may omit some blocks as shown, and the scope of the present disclosure is not limited in this regard.

At block 810, the terminal device 120 receives DCI scheduling a PDSCH transmission in a CJT scheme, the DCI indicating a set of TCI states.

At block 820, the terminal device 120 determines a TCI state in the set of TCI states for use in a further transmission, the further transmission being not performed in the CJT scheme while the PDSCH transmission is performed in the CJT scheme.

In some embodiments, the further transmission may comprise at least one of the following: a PDCCH transmission; a CSI-RS transmission on a same time-domain location as the PDSCH transmission; a PUCCH transmission; or a PUSCH transmission.

In some embodiments, the terminal device may receive an indication of the TCI state configured for the further transmission; and determine, as the TCI state, a predetermined TCI state in the set of TCI states. In some embodiments, the terminal device may determine, as the predetermined TCI state, a TCI state configured as providing reference information for the PDSCH transmission. In some embodiments where the further transmission comprises a PUCCH transmission or a PUSCH transmission, the terminal device 110 may determine, as the predetermined TCI state, a TCI state providing a downlink reference signal with a lowest pathloss in the set of TCI states.

In some embodiments, the terminal device 110 may receive information of QCL parameter compensation for the PDSCH transmission and cause the information of QCL parameter compensation to be not applied to the further transmission.

In some embodiments, the set of TCI states may comprise a first TCI state and a second TCI state. In these embodiments, the terminal device may receive a configuration indicating that the first TCI state provides reference information for the PDSCH transmission and the second TCI state provides additional information for the PDSCH transmission different from the reference information.

In some embodiments, the additional information may comprise at least one of the following: an average delay; a delay spread; a Doppler shift; a Doppler spread; a phase parameter; or a transmitting power parameter. In some embodiments, the average delay may comprise a maximum average delay of the PDSCH transmission. In some embodiments, the delay spread may comprise a maximum delay spread of the PDSCH transmission. In some embodiments, the phase parameter may comprise at least one of a phase value, an initial phase, a phase shift or a phase rotation. In some embodiments, the transmitting power parameter may comprise at least one of a power value or power offset.

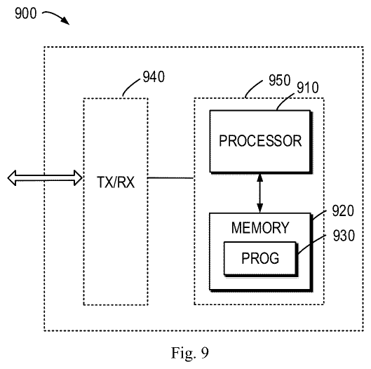

FIG. 9 is a simplified block diagram of a device 900 that is suitable for implementing embodiments of the present disclosure. The device 900 can be considered as a further example implementation of the terminal device 110 and the network device 120 as shown in FIG. 1. Accordingly, the device 900 can be implemented at or as at least a part of the terminal device 110 and the network device 120.

As shown, the device 900 includes a processor 910, a memory 920 coupled to the processor 910, a suitable transmitter (TX) and receiver (RX) 940 coupled to the processor 910, and a communication interface coupled to the TX/RX 940. The memory 910 stores at least a part of a program 930. The TX/RX 940 is for bidirectional communications. The TX/RX 940 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 930 is assumed to include program instructions that, when executed by the associated processor 910, enable the device 900 to operate in accordance with the embodiments of the present disclosure, as discussed herein with reference to FIG. 1. The embodiments herein may be implemented by computer software executable by the processor 910 of the device 900, or by hardware, or by a combination of software and hardware. The processor 910 may be configured to implement various embodiments of the present disclosure. Furthermore, a combination of the processor 910 and memory 920 may form processing means 950 adapted to implement various embodiments of the present disclosure.

The memory 920 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 920 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

In some embodiments, a terminal device comprises a circuitry configured to: receive DCI scheduling a PDSCH transmission in a CJT scheme, the DCI indicating a set of TCI states; receive information of QCL parameter compensation for the PDSCH transmission; and receive the PDSCH transmission based on the set of TCI states and the information of QCL parameter compensation.

In some embodiments, a terminal device comprises a circuitry configured to: receive DCI scheduling a PDSCH transmission in a CJT scheme, the DCI indicating a set of TCI states; and determine a TCI state in the set of TCI states for use in a further transmission, the further transmission being not performed in the CJT scheme while the PDSCH transmission is performed in the CJT scheme.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure may provide the following solutions.

In one solution, a terminal device comprises: a processor configured to cause the terminal device to: receive DCI scheduling a PDSCH transmission in a CJT scheme, the DCI indicating a set of TCI states; receive information of QCL parameter compensation for the PDSCH transmission; and receive the PDSCH transmission based on the set of TCI states and the information of QCL parameter compensation.

In some embodiments, the DCI comprises the information of QCL parameter compensation, and wherein the terminal device is caused to receive the information of QCL parameter compensation by: obtaining the information of QCL parameter compensation from the DCI.

In some embodiments, the information of QCL parameter compensation comprises at least one of the following: compensation for a time-domain parameter; compensation for a frequency-domain parameter; compensation for a phase parameter; compensation for a delay parameter; compensation for a Doppler parameter; compensation for transmitting power; or an indication indicating whether the QCL parameter compensation is applied.

In some embodiments, the terminal device is caused to receive the PDSCH transmission by: receiving a set of first reference signals based on the set of TCI states; determining a first set of QCL parameters based on a first measurement on the set of first reference signals; and receiving the PDSCH transmission based on the first set of QCL parameters and the information of QCL parameter compensation.

In some embodiments, the terminal device is caused to receive the PDSCH transmission by: determine a second set of QCL parameters by modifying the first set of QCL parameters based on the information of QCL parameter compensation; and receive the PDSCH transmission based on the second set of QCL parameters.

In some embodiments, a set of first reference signals is received based on the set of TCI states at a first timing, and the terminal device is caused to receive the PDSCH transmission by: receiving a set of second reference signals based on the set of TCI states at a second timing later than the first timing; determining a third set of QCL parameters based on a second measurement on the set of second reference signals; and receive the PDSCH transmission based on the third set of QCL parameters.

In some embodiments, a set of first reference signals is received based on the set of TCI states at a first timing. In these embodiments, the terminal device is caused to receive the PDSCH transmission by: receiving a set of second reference signals based on the set of TCI states at a second timing later than the first timing; determining a third set of QCL parameters based on a second measurement on the set of second reference signals; and receiving the PDSCH transmission based on the third set of QCL parameters and the information of QCL parameter compensation.

In some embodiments, the terminal device is further caused to: ignore a first measurement on the set of first reference signals.

In some embodiments, the set of second reference signals comprises one of the following: a set of DMRSs of the PDSCH transmission; a further set of first reference signals; or a set of third reference signals associated with the set of first reference signals.

In some embodiments, the first reference signals are TRSs or CSI-RSs.

In some embodiments, the terminal device is further caused to: report capability of the terminal device, the capability comprising at least one of the following: information of support for the QCL parameter compensation; or a time duration for the QCL parameter compensation.

In some embodiments, the terminal device is further caused to: receive the PDSCH transmission by applying the set of TCI states and the information of QCL parameter compensation after a time duration from reception of the DCI.

In another solution, a terminal device comprises: a processor configured to cause the terminal device to: receive DCI scheduling a PDSCH transmission in a CJT scheme, the DCI indicating a set of TCI states; and determine a TCI state in the set of TCI states for use in a further transmission, the further transmission being not performed in the CJT scheme while the PDSCH transmission is performed in the CJT scheme.

In some embodiments, the further transmission comprises at least one of the following: a PDCCH transmission; a CSI-RS transmission on a same time-domain location as the PDSCH transmission; a PUCCH transmission; or a PUSCH transmission.

In some embodiments, the terminal device is caused to determine the TCI state by: receiving an indication of the TCI state configured for the further transmission; or determining, as the TCI state, a predetermined TCI state in the set of TCI states.

In some embodiments, the terminal device is caused to determine the predetermined TCI state by: determining, as the predetermined TCI state, a TCI state configured as providing reference information for the PDSCH transmission.

In some embodiments, the further transmission comprises a PUCCH transmission or a PUSCH transmission, and wherein the terminal device is caused to determine the predetermined TCI state by: determining, as the predetermined TCI state, a TCI state providing a downlink reference signal with a lowest pathloss in the set of TCI states.

In some embodiments, the terminal device is further caused to: receive information of QCL parameter compensation for the PDSCH transmission; and cause the information of QCL parameter compensation to be not applied to the further transmission.

In some embodiments, the set of TCI states comprises a first TCI state and a second TCI state, and wherein the terminal device is further caused to: receive a configuration indicating that the first TCI state provides reference information for the PDSCH transmission and the second TCI state provides additional information for the PDSCH transmission different from the reference information.

In some embodiments, the additional information comprises at least one of the following: an average delay; a delay spread; a Doppler shift; a Doppler spread; a phase parameter; or a transmitting power parameter.

In some embodiments, the average delay comprises a maximum average delay of the PDSCH transmission, or the delay spread comprises a maximum delay spread of the PDSCH transmission.

In another solution, a method of communication comprises: receiving, at a terminal device, DCI scheduling a PDSCH transmission in a CJT scheme, the DCI indicating a set of TCI states; receiving information for QCL parameter compensation for the PDSCH transmission; and receiving the PDSCH transmission based on the set of TCI states and the information of QCL parameter compensation.

In another solution, a method of communication comprises: receiving, at a terminal device, DCI scheduling a PDSCH transmission in a CJT scheme, the DCI indicating a set of TCI states; and determining a TCI state in the set of TCI states for use in a further transmission, the further transmission being not performed in the CJT scheme while the PDSCH transmission is performed in the CJT scheme.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIG. 1 to 8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method, performed by a terminal device, the method comprising:
receiving, from a network device, first information comprising a first transmission configuration indicator (TCI) state and a second TCI state for a physical downlink shared channel (PDSCH) transmission; and
receiving, from the network device, a radio resource control (RRC) configuration indicating one of the first TCI state and the second TCI state applied to a first transmission comprising a physical downlink control channel (PDCCH) transmission or a channel state information-reference signal (CSI-RS) transmission,
wherein, in a case where the PDSCH transmission is in a coherent joint transmission (CJT) scheme:
QCL parameters of the second TCI state for the PDSCH transmission are different from QCL parameters of the second TCI state for the first transmission.

22. The method of claim 21, wherein, in a case where the PDSCH transmission is in the CJT scheme:
the first TCI state and the second TCI state are of a same QCL type, and the same QCL type comprises a QCL type A.

23. The method of claim 21, wherein
the first TCI state provides information of a first doppler shift, a first doppler spread, a first average delay and a first delay spread for the PDSCH transmission, and
the second TCI state provides information of a second average delay and a second delay spread for the PDSCH transmission.

24. The method of claim 21, wherein
second information is received from the network device, and the second information comprises an indication indicating whether a delay parameter compensation is applied for the PDSCH transmission.

25. The method of claim 24, wherein
the second information comprises a delay parameter for compensation for the PDSCH transmission, a phase parameter for compensation for the PDSCH transmission, and a frequency parameter for compensation for the PDSCH transmission.

26. A method, performed by a network device, the method comprising:
transmitting, to a terminal device, first information comprising a first transmission configuration indicator (TCI) state and a second TCI state for a physical downlink shared channel (PDSCH) transmission; and
transmitting, to the terminal device, a radio resource control (RRC) configuration indicating one of the first TCI state and the second TCI state applied to a first transmission comprising a physical downlink control channel (PDCCH) transmission or a channel state information-reference signal (CSI-RS) transmission,
wherein, in a case where the PDSCH transmission is in a coherent joint transmission (CJT) scheme:
QCL parameters of the second TCI state for the PDSCH transmission are different from QCL parameters of the second TCI state for the first transmission.

27. The method of claim 26, wherein, in a case where the PDSCH transmission is in the CJT scheme:
the first TCI state and the second TCI state are of a same QCL type, and the same QCL type comprises a QCL type A.

28. The method of claim 26, wherein
the first TCI state provides information of a first doppler shift, a first doppler spread, a first average delay and a first delay spread for the PDSCH transmission, and
the second TCI state provides information of a second average delay and a second delay spread for the PDSCH transmission.

29. The method of claim 26, wherein
second information is transmitted to the terminal device, and the second information comprises an indication indicating whether a delay parameter compensation is applied for the PDSCH transmission.

30. The method of claim 29, wherein
the second information comprises a delay parameter for compensation for the PDSCH transmission, a phase parameter for compensation for the PDSCH transmission, and a frequency parameter for compensation for the PDSCH transmission.

31. A terminal device, comprising a processor configured to cause the terminal device to:
receive, from a network device, first information comprising a first transmission configuration indicator (TCI) state and a second TCI state for a physical downlink shared channel (PDSCH) transmission; and
receive, from the network device, a radio resource control (RRC) configuration indicating one of the first TCI state and the second TCI state applied to a first transmission comprising a physical downlink control channel (PDCCH) transmission or a channel state information-reference signal (CSI-RS) transmission,
wherein, in a case where the PDSCH transmission is in a coherent joint transmission (CJT) scheme:
QCL parameters of the second TCI state for the PDSCH transmission are different from QCL parameters of the second TCI state for the first transmission.

32. The terminal device of claim 31, wherein, in a case where the PDSCH transmission is in the CJT scheme:
the first TCI state and the second TCI state are of a same QCL type, and the same QCL type comprises a QCL type A.

33. The terminal device of claim 31, wherein
the first TCI state provides information of a first doppler shift, a first doppler spread, a first average delay and a first delay spread for the PDSCH transmission, and
the second TCI state provides information of a second average delay and a second delay spread for the PDSCH transmission.

34. The terminal device of claim 31, wherein
second information is received from the network device, and the second information comprises an indication indicating whether a delay parameter compensation is applied for the PDSCH transmission.

35. The terminal device of claim 34, wherein
the second information comprises a delay parameter for compensation for the PDSCH transmission, a phase parameter for compensation for the PDSCH transmission, and a frequency parameter for compensation for the PDSCH transmission.
